(19) United States
(12) Patent Application Publication
(10) Pub. No.: US 2006/0101192 A1
(43) Pub. Date: May 11, 2006

(54) Systems and methods of nonvolatile memory management

(76) Inventor: Daniel V. Zilavy, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/984,478

(22) Filed: Nov. 9, 2004

(51) Int. Cl. G06F 12/00

(52) U.S. Cl. 711/103

(57) ABSTRACT

Systems and methods for implementing nonvolatile memory management are disclosed. In an exemplary embodiment a system may include a nonvolatile memory and a memory manager operatively associated with the nonvolatile memory. A plurality of management functions provided by the memory manager for accessing device data stored in the nonvolatile memory.

### TECHNICAL FIELD

The described subject matter relates to nonvolatile memory, and more particularly to systems and methods of nonvolatile memory management.

### BACKGROUND

Electronic devices are often provided with nonvolatile memory to retain data even after power is removed from the device. Exemplary nonvolatile memory includes, e.g., battery-backed or nonvolatile random access memory (NVRAM) and flash memory, and may be used to store program code and/or data such as, e.g., firmware, device configuration data, event logs, and application data (collectively referred to herein as “device data”). Accessing device data requires an understanding of the nonvolatile memory layout.

The layout of nonvolatile memory is typically defined in a common definition file, such as, e.g., a C or C++.h (“dot-h”) file. During development multiple software designers may need access to the common definition file, but the software designers must each wait until the common definition file is released by other software designers editing the common definition file before they can make changes to it. Serializing efforts of the software designers as such is inefficient and increases the cost of development.

In addition, changes to the nonvolatile memory layout may be required when the device data is updated (e.g., increasing, decreasing, and/or adding memory blocks). A special piece of program code known as a conversion module is typically provided to read existing content of the nonvolatile memory, update old device data, and then write the updated device data back to nonvolatile memory. In order to effect these changes the conversion module needs an understanding of the old and new layouts of the nonvolatile memory (e.g., memory block location and offset). Accordingly, the conversion module does not conform to object oriented design (OOD) principles for software development, which require objects to be self-contained. In addition, the conversion module may simply overwrite device data in nonvolatile memory if the conversion module does not recognize it.

### SUMMARY

In an exemplary embodiment, nonvolatile memory management may be implemented as a method, comprising: allocating via a memory manager at least one memory block in nonvolatile memory, initializing via the memory manager the at least one allocated memory block for storing device data, and generating a handle for the memory manager to provide to a client object for accessing the at least one initialized memory block.

In another exemplary embodiment, a system for nonvolatile memory management may be provided. The system may include a nonvolatile memory and a memory manager operatively associated with the nonvolatile memory. A plurality of management functions may be provided by the memory manager for accessing device data stored in the nonvolatile memory.

Another exemplary embodiment of nonvolatile memory management may be implemented as a program code product for executing a process comprising: executing an initialize function for initializing at least one memory block in nonvolatile memory, executing a write function for storing device data in the at least one initialized memory block, and generating a handle to the device data stored in the at least one memory block.

### BRIEF DESCRIPTION OF THE DRAWINGS

FIG. 1 is a schematic diagram illustrating an exemplary embodiment of nonvolatile memory management.

FIG. 2 is a high-level illustration of an exemplary memory block layout.

FIG. 3 is a schematic illustration of an exemplary management API.

FIG. 4 is a schematic diagram illustrating exemplary operations to initialize nonvolatile memory.

FIG. 5 is a schematic diagram illustrating exemplary operations to read device data in nonvolatile memory.

FIG. 6 is a schematic diagram illustrating exemplary operations to change device data in nonvolatile memory.

FIG. 7 is a schematic diagram illustrating exemplary operations to reorganize memory blocks in nonvolatile memory.

FIG. 8 is a flowchart illustrating exemplary operations to implement nonvolatile memory management.

### DETAILED DESCRIPTION

Briefly, systems and methods described herein may be implemented for nonvolatile memory management. In an exemplary embodiment, a memory manager is provided with management functions for dynamically managing nonvolatile memory. Client objects (e.g., operating system modules) access nonvolatile memory via the memory manager eliminating the need for a common definition file. Accordingly, software designers may develop object code in parallel with one another without having to each update a single common definition file.

In addition, the client objects may update device data in nonvolatile memory without depending on external conversion modules. Accordingly, the subject matter described herein complies with OOD principles for software design.

It is noted that although the subject matter described herein is illustrated with regard to nonvolatile memory, the memory management systems and methods may be extended to other forms of electronic memory, as will be readily understood by one having ordinary skill in the art after having become familiar with the teachings herein.

Exemplary System

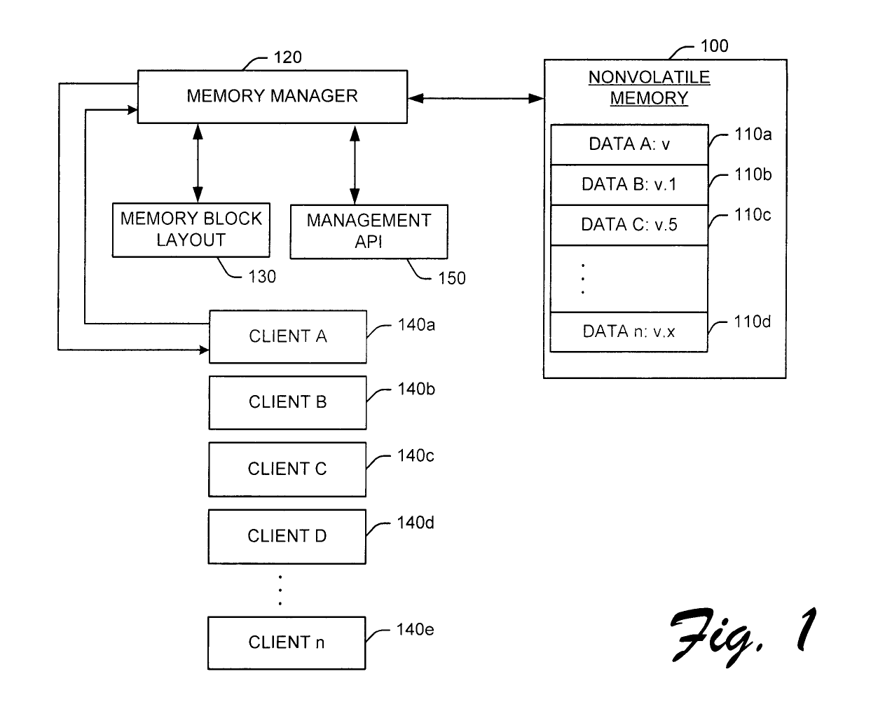

FIG. 1 is a schematic diagram illustrating exemplary nonvolatile memory management. Electronic memory may include various types of nonvolatile memory 100, such as but not limited to, nonvolatile random access memory (NVRAM) and flash memory to name only a few examples. Nonvolatile memory 100 may be organized as memory blocks 110a-d (hereinafter generally referred to as memory blocks 110) and device data may be stored in contiguous or noncontiguous memory blocks 110. A memory manager 120 may be operatively associated with nonvolatile memory 100 to manage the memory blocks 110.

Memory manager 120 may be implemented as one or more execution modules for accessing device data in the memory blocks 110. Memory manager 120 may also retrieve device data from nonvolatile memory 100 and pass the device data to a run-time call stack (e.g., for execution). In an exemplary embodiment memory manager 120 generates and maintains a memory block layout 130, e.g., a map for locating device data stored in nonvolatile memory 100.

Memory manager 120 may cooperate with client objects 140a-e (hereinafter generally referred to as clients 140) to provide access to device data stored in nonvolatile memory 100, e.g., to load firmware for operation of the device. As used herein, the terms “client object” and “client” refer to software or object code used to perform various computing services for the device. For example, clients 140 may include operating systems, device drivers, and applications. Clients 140 may also be responsible for evaluating the version of the device data and updating the device data as needed.

Memory manager 120 may broker memory management services for the clients 140 via a management application programming interface (API) 150. Management API 150 may be implemented to perform various operations on the memory blocks, such as, e.g., allocate/deallocate, open/close, and read/write/delete operations, as described in more detail below.

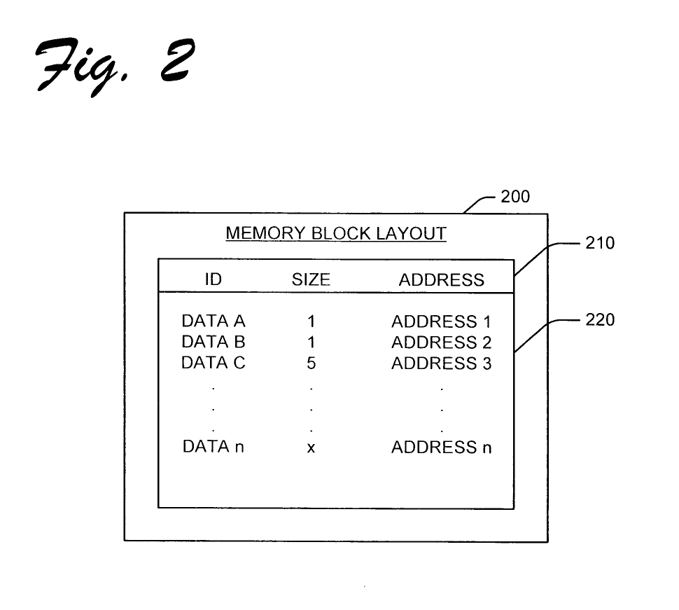

FIG. 2 is a high-level illustration of an exemplary memory block layout (such as the memory block layout 130 in FIG. 1). Memory block layout 200 may include a number of fields 210 and corresponding information 220 for the memory blocks in nonvolatile memory. Accordingly, memory manager (e.g., memory manager 120 in FIG. 1) may use memory block layout 200 to locate device data so that clients do not need specific information for how the device data is stored in nonvolatile memory. Indeed, device data need not be stored in contiguous memory blocks and may be accessed from noncontiguous memory blocks via the memory manager using the memory block layout 200.

In an exemplary embodiment, memory block layout 200 may be implemented as a data structure including a number of data fields, as illustrated in Table 1.

TABLE 1
Exemplary Memory Block Layout

| Field | Contents |
|---|---|
| Device Data ID | DataA, DataB, DataC, . . . |
| Data Size | 1, 1, 5, . . . |
| Memory Block | Block1, Block2, Block3, . . . |
| Location or Address | |
| Handle | CodeA.1.Block1; CodeB.1.Block2, . . . |

The data structure may be populated, e.g., by the memory manager. In an exemplary embodiment the memory manager may “walk” the memory blocks of nonvolatile memory, gathering information on the memory blocks and using this information to generate a memory block layout. The memory manager may also update the memory block layout when changes are made to the nonvolatile memory.

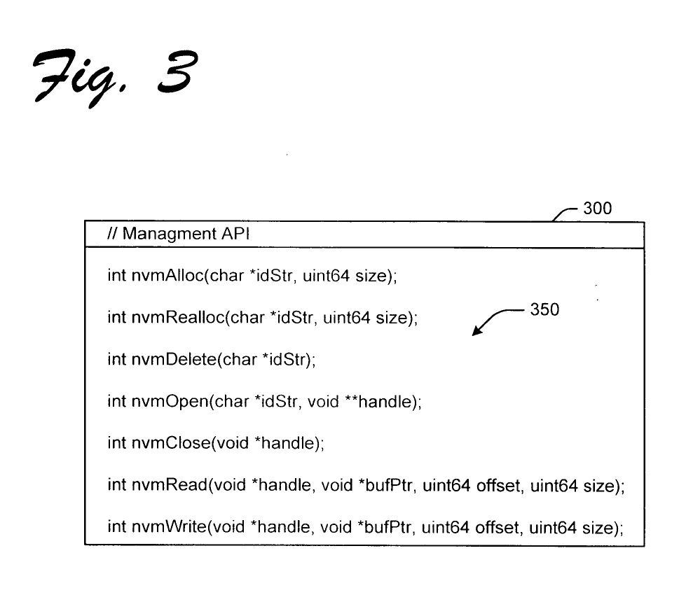

FIG. 3 is a schematic illustration of an exemplary management API (such as the management API 150 in FIG. 1). In general APIs allow software developers to write flexible, modular program code which may be readily updated by modifying or replacing objects instead of having to rewrite entire applications.

In an exemplary embodiment, management API 300 may include the following management functions: Allocate, Reallocate, Delete, Open, Close, Read, and Write. It is noted, however, that management API 300 is not limited to any particular management functions 350. For example, management API 300 does not need to include each of the management functions 350 shown in FIG. 2(b). In addition, management API 300 may include other management functions not shown.

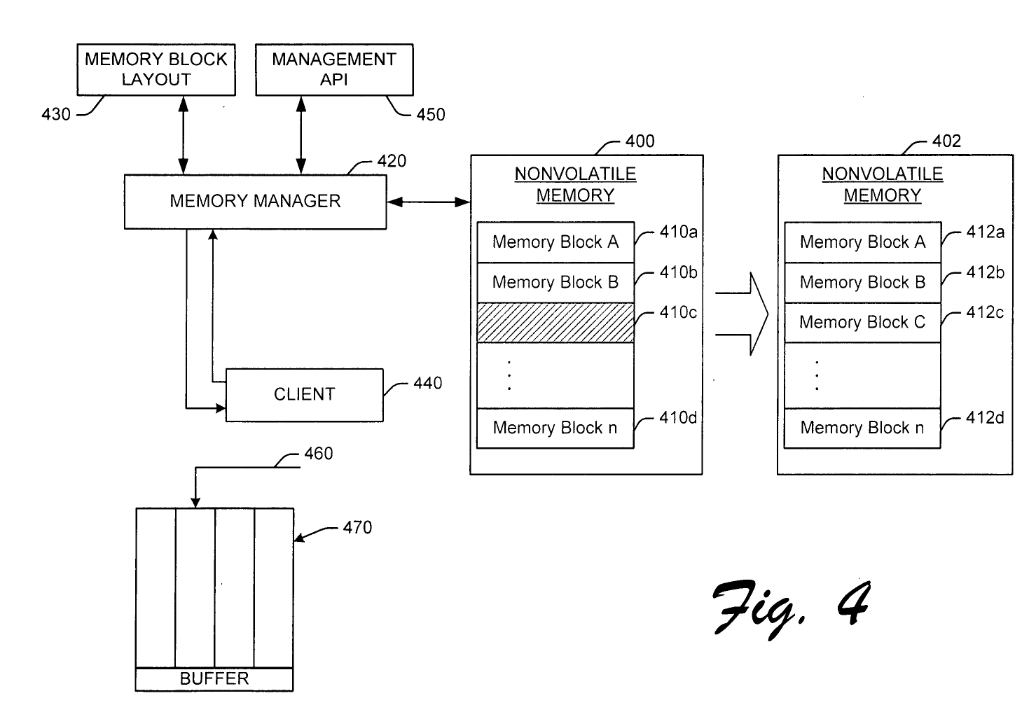

FIG. 4 is a schematic diagram illustrating exemplary operations to initialize nonvolatile memory 400. Nonvolatile memory including the initialized memory block is illustrated as nonvolatile memory 402 in FIG. 4. Before continuing it is noted that 400-series reference numerals are used to refer to corresponding elements described above with reference to FIG. 1.

In an exemplary embodiment, client 440 may attempt to open a memory block 410 in nonvolatile memory 400 to access device data. Memory manager 420 may access memory block layout 430 to determine if a memory block 410 is allocated for client 440. If the memory block is not allocated for client 440 (e.g., the time client 440 executes), client 440 may initialize a new memory block 410c for the device data as follows.

Client 440 may initialize a new memory block as follows. Client 440 calls the nvmAlloc function, passing an ID string and block size for the new memory block to the memory manager 420. Memory manager 420 locates available memory block(s) (e.g., 410c) in nonvolatile memory 400 and returns a success or failure for the available memory block(s) 410c.

Client 440 may then open the memory block 410c by calling the nvmOpen function. Client 440 passes the ID string and a pointer to the handle to the memory manager 420. Memory manager 420 may then open the memory block 410c and return a handle for the open memory block 410c to the client 340.

Client 440 may then initialize the memory block 410 by calling the nvmWrite function. Client 440 passes the handle and a pointer 460 to a buffer 470 containing initialization data, an offset relative to the memory block opened by the client, and the buffer size to the memory manager 420. Memory manager 420 accesses the initialization data from the buffer 470 and writes it in open memory block 410c, as illustrated by new memory block 412c in the updated nonvolatile memory 402.

Client 440 may optionally close the memory block 412c after it is initialized by calling the nvmClose function. Client 440 passes the handle for open memory block 412c to the memory manager 420 which closes the open memory block 410.

Memory manager 420 may also update memory block layout 430 with a handle to memory block 412c. Memory manager 420 may then return a handle for device data in memory block 412c when client 440 requests access thereto.

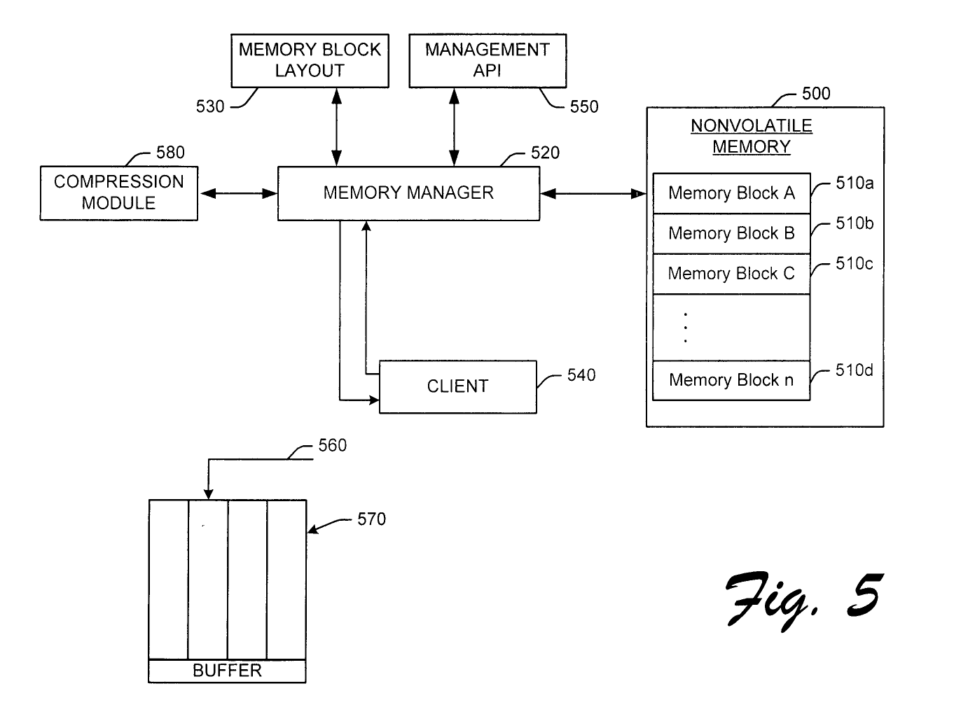

FIG. 5 is a schematic diagram illustrating exemplary operations to read device data in nonvolatile memory 500. Again it is noted that 500-series reference numerals are used to refer to corresponding elements described above with reference to FIG. 1.

In an exemplary embodiment, client 540 may access a memory block 510a-d (hereinafter generally referred to as memory blocks 510) to read device data in nonvolatile memory 500 as follows. Client 540 calls the nvmOpen function if the memory block 510 is not already open. Memory manager 520 locates the memory block 510 (e.g., using memory block layout 530) and returns a handle for the memory block 510. If the memory block 510 is already open this operation may be skipped.

When the memory block 510 is open, client 540 may call the nvmRead function. Client 540 passes the handle for the memory location 510, a pointer 560 to a buffer 570, an offset relative to the memory block opened by the client, and the buffer size. Memory manager 520 retrieves device data from the memory block 510 and writes it to the buffer 570 for access by the client 540. After reading the device data, client 540 may optionally close the memory block 510 by calling the nvmClose function.

In an exemplary embodiment, memory manager 520 may also include a compression module 580. Memory manager 520 may access compression module to compress device data before storing the compressed device data in nonvolatile memory 500. Memory manager 520 may also access compression module to decompress device data retrieved from nonvolatile memory 500 before returning the device data to the client 540.

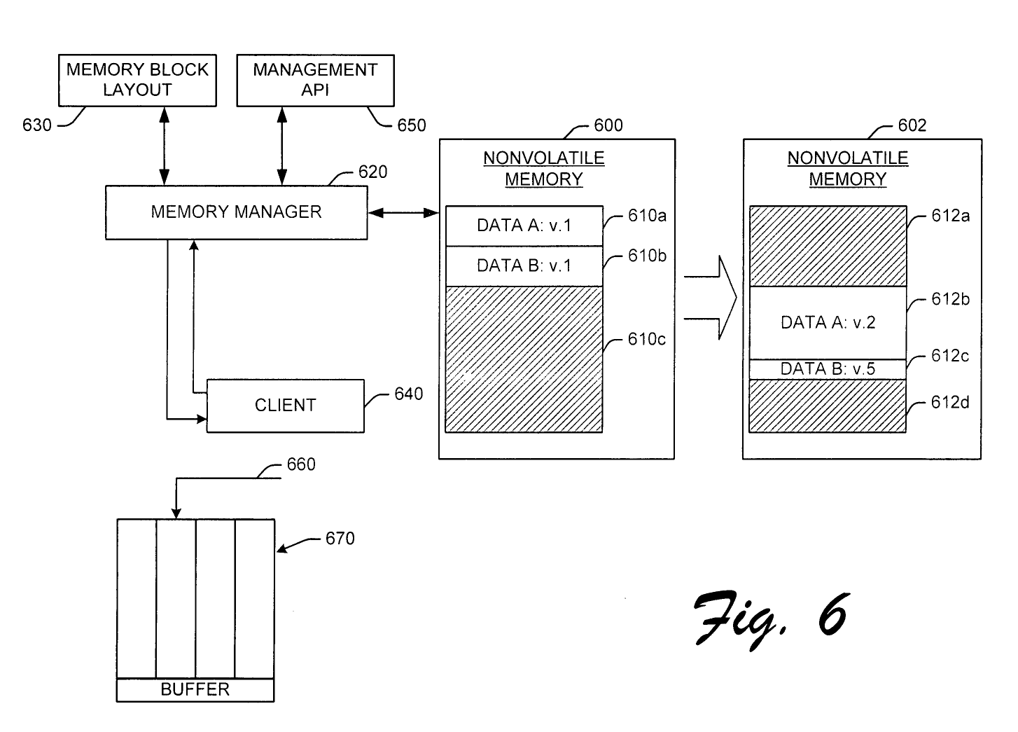

FIG. 6 is a schematic diagram illustrating exemplary operations to change (e.g., update) device data in nonvolatile memory 600. The updated nonvolatile memory is illustrated as nonvolatile memory 602 in FIG. 6. Again it is noted that 600-series reference numerals are used to refer to corresponding elements described above with reference to FIG. 1.

In an exemplary embodiment, client 640 may change device data in nonvolatile memory 600 by calling the nvmRealloc function. Client 640 passes the ID string for the existing device data to the memory manager 620, along with a new block size.

If the new block size is larger for the updated device data, the nvmRealloc function may allocate a new memory block from a pool 610c of available memory blocks in nonvolatile memory 600 and copy the contents of the old memory block 610a into the new memory block 612b. The remainder of the new memory block 612b may be filled with zeros until client 640 calls the nvmWrite function to write the new device data to new memory block 612b. The nvmRealloc function may also include a function to release the old memory block.

If the new block size is smaller for the updated device data, nvmRealloc may allocate a new memory block from a pool 610c of available memory blocks in nonvolatile memory 600 and copy the contents of the old memory block 610b into the new memory block 612b up to the size of the new memory block 612b. Client 640 may then call the nvmWrite function to write the new device data to the new memory block 612b. The nvmRealloc function may also include a function to release the old memory block.

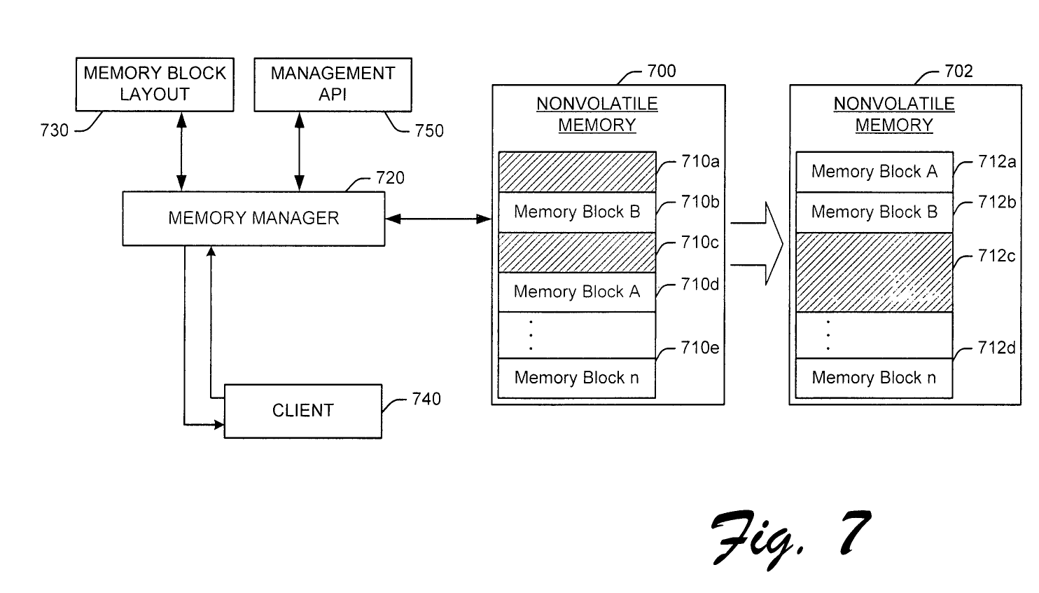

FIG. 7 is a schematic diagram illustrating exemplary operations to reorganize memory blocks in nonvolatile memory 700. For example, nonvolatile memory may be defragmented so that the used memory blocks grouped together at the start of nonvolatile memory and the empty memory blocks are grouped together at the end of nonvolatile memory. The reorganized nonvolatile memory is illustrated as nonvolatile memory 702 in FIG. 7. Again it is noted that 700-series reference numerals are used to refer to corresponding elements described above with reference to FIG. 1.

Defragmenting nonvolatile memory 700 may be initiated by the memory manager 720. Memory manager 720 may allocate a new memory block 712a and copy the contents of another memory block 710d into the new memory block 712a. Memory manager 720 may then delete the contents of the old memory block 710d and return the old memory block 710d to a flee pool 712c. This process may be repeated until the nonvolatile memory 700 is defragmented.

It is noted that the memory manager described herein may dynamically manage nonvolatile memory. Device data may be stored at any location(s) in nonvolatile memory and need not be stored in contiguous memory blocks because the clients do not need specific information concerning the physical location of device data in nonvolatile memory. Indeed, the physical location of device data may change (e.g., during a defragmenting operation), and clients are still able to access device data in nonvolatile memory via management functions provided by the memory manager.

It is noted that the exemplary embodiments discussed above are provided for purposes of illustration. Still other embodiments of the described subject matter are also contemplated.

Exemplary Operations

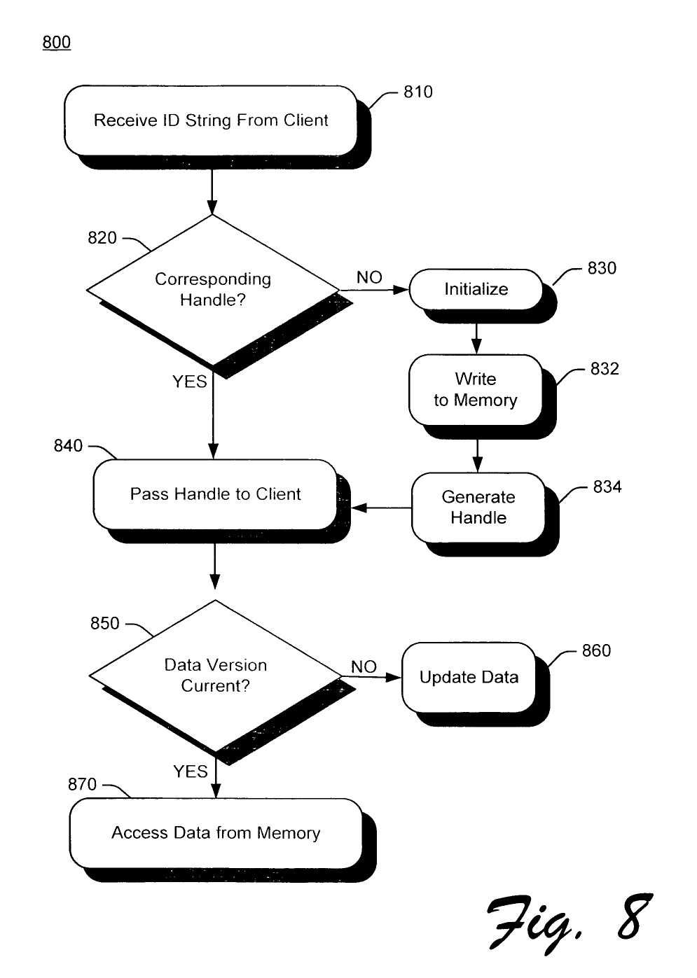

FIG. 8 is a flowchart illustrating exemplary operations to implement nonvolatile memory management. Operations 800 may be embodied as logic instructions on one or more computer-readable medium. When executed on a processor, the logic instructions cause a general purpose computing device to be programmed as a special-purpose machine that implements the described operations. In an exemplary embodiment, the components and connections depicted in the figures may be used to implement nonvolatile memory management.

In operation 810, an ID string may be received from a client. For example, the ID string may identify device data residing in nonvolatile memory. A determination is made whether there is a corresponding handle for the ID string in operation 820. For example, an update may include new device data that needs to be written to nonvolatile memory on the first operation after installing the update. If there are no corresponding handles, nonvolatile memory may be initialized in operation 830 and the new device data may be written to nonvolatile memory in operation 832. A data structure may also be updated with a handle for the new device data in operation 834.

In operation 840, the handle is passed to the client. For example, the handle may include a memory block location in nonvolatile memory to access device data corresponding to the ID string. A determination is made whether the version is current in operation 850. For example, the client may make this determination based on version information included in the handle. The device data may be updated in operation 860 if the version is not current. For example, the client may update device data in nonvolatile memory using the management functions provided at the memory manager. In operation 870 nonvolatile memory may be accessed if the version is current. For example, the client may access device data residing in nonvolatile memory using the handle and management functions provided at the memory manager.

The operations shown and described herein are provided to illustrate exemplary embodiments of nonvolatile memory management. It is noted that the operations are not limited to those shown and described with reference to FIG. 8.

1. A method of nonvolatile memory management comprising:
allocating via a memory manager at least one memory block in nonvolatile memory;
initializing via the memory manager the at least one allocated memory block for storing device data; and
generating a handle for the memory manager to provide to a client object for accessing the at least one initialized memory block.

2. The method of claim 1 further comprising issuing the handle to the client object in response to a call from the client object identifying the device data stored in the nonvolatile memory.

3. The method of claim 1 further comprising the memory manager writing device data to the at least one initialized memory block for the client.

4. The method of claim 1 further comprising the memory manager reading device data from the at least one initialized memory block for the client.

5. The method of claim 1 further comprising the memory manager changing device data from the at least one initialized memory block for the client.

6. The method of claim 1 further comprising the memory manager defragmenting the nonvolatile memory.

7. The method of claim 1 further comprising determining a version of the device data stored in the at least one memory block.

8. The method of claim 7 further comprising updating the device data via the memory manager based on the version of device data.

9. A system for nonvolatile memory management, comprising:
a nonvolatile memory;
a memory manager operatively associated with the nonvolatile memory; and
a plurality of management functions provided by the memory manager for accessing device data stored in the nonvolatile memory.

10. The system of claim 9 further comprising a memory block layout identifying locations of the device data in the nonvolatile memory for providing access to the device data via the memory manager.

11. The system of claim 9 further comprising at least one client for accessing the device data via the memory manager.

12. The system of claim 11 wherein the at least one client is coded as an object in an object-oriented design environment.

13. The system of claim 9 wherein at least one client object updates the device data stored in nonvolatile memory via the memory manager.

14. The system of claim 9 wherein the plurality of management functions are coded as public APIs.

15. The system of claim 9 wherein the plurality of management functions include at least one of the following public APIs: nvmAlloc, nvmRealloc, nvmDelete, nvmOpen, nvmClose, nvmRead, and nvmWrite.

16. A program code product for executing a process for nonvolatile memory management, the process comprising:
executing an initialize function For initializing at least one memory block in nonvolatile memory;
executing a write function for storing device data in the at least one initialized memory block; and
generating a handle to the device data stored in the at least one memory block.

17. The program code product of claim 16 wherein the process further comprises issuing the handle to a client object when the client object calls the device data stored in the nonvolatile memory.

18. The program code product of claim 16 wherein the process further comprises executing a read function for a client object to read device data from the at least one memory block.

19. The program code product of claim 16 wherein the process further comprises executing a plurality of management functions to update device data in the at least one memory block.

20. The program code product of claim 16 wherein the process further comprises executing a plurality of management functions to defragment the nonvolatile memory.

21. A system comprising:
means for allocating at least one memory block in nonvolatile memory;
means for storing device data in the at least one initialized memory block;
handle means for accessing the at least one memory block; and
means for providing the handle means to a client object.

22. The system of claim 21 further comprising means for issuing the handle means to the client object in response to a call from the client object.
